(19) United States
(12) Patent Application Publication
(10) Pub. No.: US 2024/0221080 A1
(43) Pub. Date: Jul. 4, 2024

(54) SYSTEM AND METHOD FOR ASSET ACQUISITION WITH ENHANCED DUE DILIGENCE AND ENTITY PRE-SCREENING

(71) Applicant: EVERCHAIN GLOBAL HOLDINGS LLC, Henderson, NV (US)

(72) Inventor: Matthew T. Wratten, Henderson, NV (US)

(21) Appl. No.: 18/404,788

(22) Filed: Jan. 4, 2024

Related U.S. Application Data
(60) Provisional application No. 63/436,977, filed on Jan. 4, 2023.

(51) Int. Cl. G06Q 40/04

(52) U.S. Cl. CPC G06Q 40/04

(57) ABSTRACT

There are provided systems and systems and methods to manage transfer of assets between an asset owner and a qualified buyer. More particularly, embodiments of the present invention support a platform that enables collection, screening, vetting, managing and auditing buyer compliance data so that sellers may transfer assets in a manner that complies with a complex regulatory framework and protects borrowers' personally identifiable information. Aspects of the present invention manage accession of clients to a network of buyers and sellers administrated by platforms of the present invention, and consumer/borrower complaint management and tracking is provided to further ensure consumers are protected after sale of their corresponding loans to third parties. Further, assessment, timing, and management of outsourcing debt to collection agencies/vendors is provided for in various embodiments.

### CROSS REFERENCE TO RELATED APPLICATION

This application claims full benefit of and priority to U.S. provisional patent application Ser. No. 63/436,977 filed Jan. 4, 2023, titled, “System and Method for Asset Acquisition with Enhanced Due Diligence and Entity Pre-Screening,” the disclosure of which is fully incorporated herein by reference for all purposes.

### FIELD AND BACKGROUND OF THE INVENTION

### Field of the Invention

The present disclosure generally relates to systems and systems and methods to manage transfer of assets between an asset owner and a qualified buyer. More particularly, embodiments of the present invention support a platform that enables collection, screening, vetting, managing and auditing buyer compliance data so that sellers may transfer assets in a manner that complies with a complex regulatory framework and protects borrowers' personally identifiable information.

### Background of the Invention

Banks and other financial institutions offer loans and a variety of credit vehicles to borrowers, and inevitably, some percentage of the borrowers become unable (or unwilling) to repay loans in the agreed-upon manner. In time, underperforming or nonperforming loans can become significant financial burdens to the financial institutions, and because of the difficulties, expense, and reputational costs that accompany the debt collection process, the financial institutions often seek to find buyers for the nonperforming loans rather than undertaking collections directly. An opportunity exists, then, for a buyer to acquire the nonperforming loan assets of a creditor (at a discounted face value) and then pursue collections to recover funds from the borrowers respectively associated with the loan assets, and accordingly, the financial institution/creditor is partially reimbursed for the bad debt arising from the nonperforming loans and is theoretically alleviated from the costs and difficulties of collection. However, when a buyer offers to purchase a portfolio of nonperforming loan assets of a creditor, the offered purchase price is not the only consideration the selling creditor must take into account; because of potential legal and reputational risks that may come back to affect the creditor, the seller must consider the ability for the buyer to collect funds in compliance with all applicable laws, such as the Fair Debt Collection Practices Act (FDCPA), in addition to numerous other local, state, and federal regulations; however, prior practices provide no effective way for debt portfolio sellers to consider multiple buyers in view of their trustworthiness as debt collectors. Further, selling creditors also need to be assured that prospective buyers will utilize collection agencies (also referred to herein as “agents” or “vendors”) that are suitably qualified to conduct collection efforts in accordance with applicable regulatory standards, however, prior processes lacked the ability to provide confirmation of vetting and certification of collection agencies that may be used by buyers. Further, as recently as a decade ago, creditors defined debt collection agency management (also referred to as “vendor management”) as strictly evaluating agency performance and ensuring adherence to negotiated work efforts. Creditors often took a hands-off approach allowing collection agencies free reign over customer interactions. The practice was so prevalent that collection agency contracts contained “interference” clauses prohibiting creditor involvement after placement. This practice exacerbated problems identified above.

Thus, selling creditors need a process to ensure that the buyers who offer to purchase the underperforming/nonperforming loan assets (along with any collection agencies such buyers may use) are poised to undertake collections processes in a manner that does not result in abusive, unfair or deceptive practices to collect debts, protects confidentiality of borrowers' personally identifiable information, and does not damage the reputation or brand of the originating institution. As may be appreciated, such processes should not only be reviewed at time of sale of debt assets, but continually monitored by the selling financial institutions to ensure that the buyers remain in full compliance with applicable law over time, and in certain instances, the seller may intervene or offer to purchase back specific debt to mitigate identified issues. For example, intervention may be required to address legal issues with the underlying loan accounts, fraud allegations, paid prior claims, deceased borrowers, bankruptcies, and SCRA (Service members Civil Relief Act) applicability; however, prior approaches do not provide for a capability to ensure continued protection of the seller and borrowers in such instances.

Additionally, when a buyer is reviewing to purchase an offered portfolio of debt assets, it is also helpful for the buyer to understand the likelihood that the debts within the portfolio can be effectively collected. However, in prior methods, for buyers to individually assess the ability of borrowers to fully or partially repay loans in the portfolio, personally identifiable information (PII) of borrowers was revealed by the financial institutions to allow the potential buyers to investigate the propensity to pay for the borrowers in the portfolio. This transmission of PII puts borrowers at risk for misuse of their personal information, subjects them to potential identity theft if the information is not properly secured, and may lead to violation of numerous laws and regulations.

What is needed, then, is a system that allows sellers of loan-related assets to preview qualified/certified buyers to make a determination as to whom is the “best fit” to purchase and receive their non-performing loan portfolio to protect borrowers and the financial institution that originated the loans. What is also needed is a platform that enables creditors to not only sell their debt but manage and monitor all post-sale activity efficiently and effectively for the life of the sold accounts to ensure debt is being collected in an ethical and legal manner. What is also needed is a system and method to collect, screen, vet, manage, and audit buyer compliance data, and to continue to track buyer compliance obligations such as licensing and insurance. What is also needed is a system to provide potential buyers with propensity to pay information regarding a particular debt portfolio without revealing PII of individual creditors within the portfolio. What is also needed is a system to allow ongoing monitoring of borrower complaints and solutions to manage buy-back requests while and managing and administrating buyer compliance to applicable regulations. What is also needed is a mechanism for sellers and buyers to communicate information regarding borrower complaints and to assist with tracking and resolution of borrower complaints.

### SUMMARY OF THE INVENTION

The following summary of the invention is exemplary and explanatory only and is not necessarily restrictive of the invention as claimed. It should be noted that in various embodiments, description is made with reference to figures. However, certain embodiments may be practiced without one or more of these specific details, or in combination with other known methods and configurations. In the following summary and detailed description, numerous details are set forth, such as specific configurations, dimensions and processes, etc., in order to provide a thorough understanding of the present invention. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “an embodiment,” or the like in various places throughout this specification are not necessarily referring to the same embodiment of the invention. Furthermore, the particular features, structures, configurations, or characteristics may be combined in any suitable manner in one or more embodiments. Additionally, the terms “borrower,” and “consumer,” referring to entities that received credit or a loan from a creditor, may be used interchangeably herein. Furthermore, the terms, “creditor,” “originator,” and “issuer,” referring to entities that provided credit to a borrower, may be used interchangeably herein.

Most borrower complaints stem from a lack of due diligence and compliance oversight during recovery efforts. When due diligence and compliance oversight are lacking, the door is left open to noncompliant operations resulting in a poor experience for borrowers, such as inadequate control over personally identifiable information, failure to timely or completely respond to inquiries, balance disputes, allegations of fraud, and use of degrading language, threats, or harassing activities. The traditional way of managing recovery simply does not protect the borrowers nor does it protect the creditor from reputational, legal, or financial risk arising from buyers' and agencies' mishandling of the collections process.

Embodiments of the present invention provide a comprehensive platform to allow creditors to convey portfolios of loans to adequately qualified buyers in a manner that enhances debt collection compliance throughout the entire recovery process (for all stakeholders) by supporting a complete, end-to-end technology platform. The various embodiments provide creditors and buyers with access to a complete solution that fosters compliance during the sale; further, embodiments support full post-sale oversight long after the deal closes and deliver rich data insights to enhance and optimize recovery and collection efforts.

Embodiments of a technology platform of the present invention gives creditors the ability, in real time, to digitally access universal due diligence results performed on every company the creditor is considering doing business with, along with historical universal due diligence on every company that the creditor has done business with through the platform in the past. Additional improvements provide that data items are organized in such a fashion as to make it straightforward for the creditor to find the exact items needed, where access to such information was not available in prior approaches. Further, in various embodiments, unique metrics can be computed and provided to creditors to further inform the creditor regarding the expected performance of prospective buyers and/or agencies. For example, but not by way of limitation, in various aspects, one or more scoring metrics may be computed (for instance, by Scoring Module 161) and provided by embodiments of the present invention, and such metrics may, for instance, provide creditors visibility into the aggregate experience that borrowers or consumers have when communicating with client debt buyers and collection agencies that are working to resolve the account balances. This scoring metric, which may be referred to as a “BX Score” (Borrower Experience Score) in some embodiments, is prepared from information such as substantiated complaints received against a particular buyer/agent, post-sale response rates and timeframes for the particular buyer/agent, funding deadline, among other information. In one aspect, the BX Score may be computed from a total number of substantiated complaints against a particular buyer divided by the total number of accounts purchased and/or serviced by that buyer, and in one optional embodiment, this quotient may be multiplied by a predetermined scaling constant. Thus, in various aspects, the BX Score value provides a seller with deeper insight into how compliant the client buyer's/agency's collection strategy is, and may provide buyers additional guidance in selecting an appropriate collection agency. This visibility of a Buyer Experience Score provided by embodiments of the present invention was not ascertainable in prior methods, it being practically impossible to assess how consumers experienced the debt recovery process by particular buyers, thus aspects of the present invention provide a technical enhancement over the prior debt conveyance processes through allowing selection of buyers (and agencies, in certain scenarios) in a way that will protect both borrowers and sellers of the consumer debt. Additional metrics may be provided in various embodiments, including: a Deal Experience Score or “DX Score” that is based on factors that go into closing the deal such as responsiveness to funding deadline timeframes (e.g., measuring how long it takes for buyers to fund sellers), and a “PDX Score”—Post Sale Experience Score—based on buyer-seller interaction/response times post-sale.

Additionally, aspects of the present invention provide for updating of buyer-supplied due diligence materials as they expire or periodically, for instance annually, through a buyer (or agency) certification and recertification process. Aspects of the present invention provide additional metrics to assist in quantifying the status/performance of a particular client when that client is certifying/recertifying. For example, but not by way of limitation, a “UDD Score” may be computed and provided as a mechanism to show internal System Platform/UDD Platform users and the applying party (whether buyer or agency) how close they are to completion of the certification process. For example, required documents/data items submitted by a buyer/agency that are accepted during the vetting/analysis process raise the UDD Score until all required documents/data items are submitted and accepted, at which point, certification/recertification would be deemed complete and the UDD Score reflects successful completion of the certification/recertification process. In one embodiment, the UDD Score may represent a percentage completion of the certification/recertification process.

In yet another embodiment, aspects of the invention provide for a consumer complaint portal and management system through which creditors, buyers, and agencies can communicate about and resolve consumer concerns regarding the collection process on their respective accounts. The complaint management system allows for a secure communication channel to resolve complaints, for the System Provider to substantiate or disallow the complaint to determine whether the complaint should affect the BX score, and for storage and retrieval at a later time of information relative to the complaint if necessary. Additionally, if a buyer is allowed to re-sell assets of the debt portfolio to another buyer (presumably by the seller preauthorizing that process to proceed), embodiments of the present invention provide for subsequent screening and vetting of the new buyer, and in the instance of a secondary sale, for post-sale complaint handling and management.

There is also provided, more specifically, a method for screening a client as a potential buyer or seller of debt assets, the method comprising: setting up client jurisdictions, document categories, list of required documents, and business entity types; creating a list of required documents to be uploaded for the client for completion of a universal due diligence packet; requesting the client upload the documents, and receiving said documents uploaded by the client; analyzing the uploaded documents for completeness; requesting upload of any optional additional information from the client, and receiving said uploaded information from the client; generate a universal due diligence (UDD) package; and format the UDD package for downloading by another user. As mentioned above, aspects of the invention provide for computing metrics related to a buyer or seller's performance in managing the sale, transfer, and collection of debt assets, and reporting said metrics to the client. Further embodiments of the present invention also provide for the managing of post-sale consumer complaints through a consumer complaint portal, and tracking performance of the buyer and/or collection agent utilized by the buyer and reporting metrics related to the tracked performance. More particularly, in the context of loan management, a “Recover” subsystem or function is provided that addresses the process of collecting overdue payments or defaulted loans from borrowers who have failed to meet their financial obligations according to the loan agreement. When a borrower misses payments or defaults on a loan, the lender (also referred to as the “original creditor”) takes various actions to recover the outstanding amount, which includes contacting the borrower, negotiating new payment plans, sending reminders, imposing penalties, legal action, collateral liquidation, or engaging with a third-party debt collection agency. Aspects of the present invention thus provide Recover functionality to assist with administration of third party collections.

Further, system clients may be periodically notified about ongoing requirements to provide additional documents or recertification information; more specifically, embodiments of the present invention provide for monitoring a client recertification criterion; providing a notice to the client regarding the requirements to recertify; accepting uploaded documents from the client regarding the certification; and analyzing said documents to determine whether recertification requirements are met.

More specifically, there is provided a method for screening a client as a potential buyer or seller of debt assets, the method comprising: setting up client jurisdictions, document categories, list of required documents, and business entity types; creating a list of required documents to be uploaded for the client for completion of a universal due diligence packet; requesting the client upload the documents, and receiving said documents uploaded by the client; analyzing the uploaded documents for completeness; requesting upload of any optional additional information from the client, and receiving said uploaded information from the client; generating a universal due diligence (UDD) package; and formatting the UDD package for downloading by another user. Further, metrics may be computed that are related to a buyer or seller's performance in managing the sale, transfer, and/or collection of debt assets. These metrics, for example, may include one or more of a Borrower Experience (BX) Score, a Deal Experience (DX) Score, a Post-Sale Experience (PDX) Score, and a Universal Due Diligence (UDD) Score. The BX Score may be computed as a function of one or more of: a number of substantiated complaints received against a particular buyer/agent; post-sale response rates for the particular buyer/agent; post-sale performance timeframes for the particular buyer/agent; and performance of the particular buyer/agent to a funding deadline. The BX Score may be computed from a total number of substantiated complaints against a particular buyer divided by the total number of accounts purchased and/or serviced by that buyer, and in some embodiments, the computed BX complaint/accounts purchased quotient may be multiplied by a predetermined scaling constant. Further, the DX Score may be computed as a function of responsiveness of a party to a funding deadline timeframe, and the PDX Score may be computed as a function of post-sale buyer-seller response times. Also, the UDD Score may be computed be computed as a percentage completion of a certification/recertification process.

Methods of the present invention may also comprise managing post-sale consumer complaints through a consumer complaint portal, and tracking performance of the buyer and/or collection agent utilized by the buyer; and reporting metrics related to the tracked performance. Additional embodiments also include monitoring a client recertification criterion; providing a notice to the client regarding the requirements to recertify; accepting uploaded documents from the client regarding the certification; and analyzing said documents to determine whether recertification requirements are met.

In yet another embodiment, setting up client jurisdictions, document categories, list of required documents, and business entity types further comprises: setting up client jurisdictions by establishing fields in a nontransitory UDD.Jurisdiction data structure by transferring an entity name, entity type (city, county, state, and country) and description of the client into the respective fields. Further, setting up client jurisdictions may further comprise: setting up client jurisdictions by establishing fields in a nontransitory data structure by transferring an entity name, entity type (city, county, state, and country) and description of the client into respective fields; and entering licensing information regarding the client into a second nontransitory data structure to enable sellers to aware of where the client and/or agency can legally transact.

In an additional further embodiment, setting up document categories further comprises: transferring name and description data regarding a document into a nontransitory category data structure, including a flag indicating whether the category is in use, and in one further aspect the category may further include one or more of: Business & Officers Information, Legal & Regulatory History, Security & Data Protection, Licensing, Insurance, Employee Hiring, Training & Testing, Quality Assurance & Internal Audit, and Vendor Management & Agency Oversight. Additionally, aspects may include further transferring via a foreign key to nontransitory data structure document category: license and/or insurance expiration information regarding a client entity; a flag indicating whether a referenced document is required; and a second flag indicating whether the document must be associated to jurisdictions.

### BRIEF DESCRIPTION OF THE DRAWINGS

A more complete understanding of the present invention may be derived by referring to the detailed description and claims when considered in connection with the following illustrative figures. Identical reference numerals refer to the same or similar parts throughout the included drawings.

FIG. 1 illustrates a block diagram of a system of the present invention, including the System Platform, and UDD and Marketplace sub-platforms within the System Platform.

FIG. 1A illustrates a block diagram of a system of the present invention, including a Recover Subsystem addition to the UDD and Marketplace subsystems.

FIG. 1B shows a modified embodiment of the system shown in FIG. 1, including features integrating the Recovery Management solution 105A.

FIGS. 1B and 1C show alternative embodiments of the system shown in FIG. 1, including features integrating Recovery Management solutions.

FIG. 2 illustrates a block diagram of another aspect of the present invention, providing details of the UDD UI module.

FIG. 3 shows a functional diagram of a client setup process all the way down to due diligence package generation of the present invention.

FIG. 4 illustrates a process flow showing steps of the client/document setup process.

FIG. 5 illustrates an additional process flow showing steps of the client/document setup process.

FIG. 6 illustrates yet another process flow showing steps of the client/document setup process.

FIGS. 7A-7C provide a schematic presentation of an entity-relationship diagram showing an embodiment of a data structure of the present invention.

FIGS. 8A-8B provide additional schematic presentations of an entity-relationship diagram showing an embodiment of a data structure of the present invention.

FIG. 9 provides another schematic presentation of entity-relationship diagrams showing an embodiment of a data structure of the present invention.

FIG. 10 provides another schematic presentation of entity-relationship diagrams showing an embodiment of a data structure of the present invention.

### DETAILED DESCRIPTION

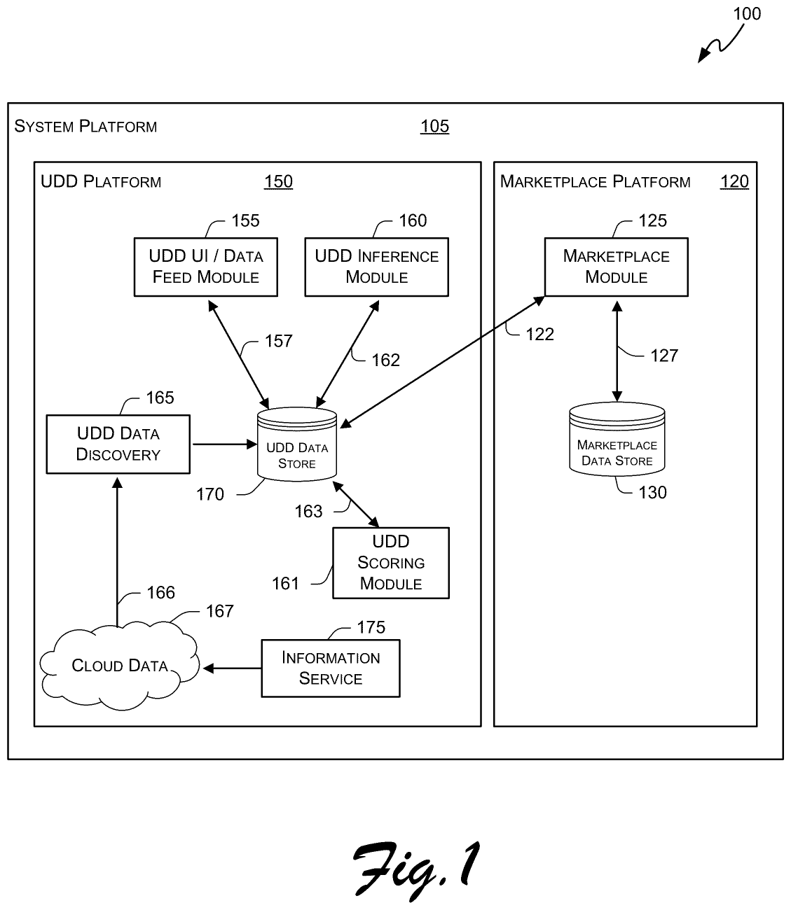

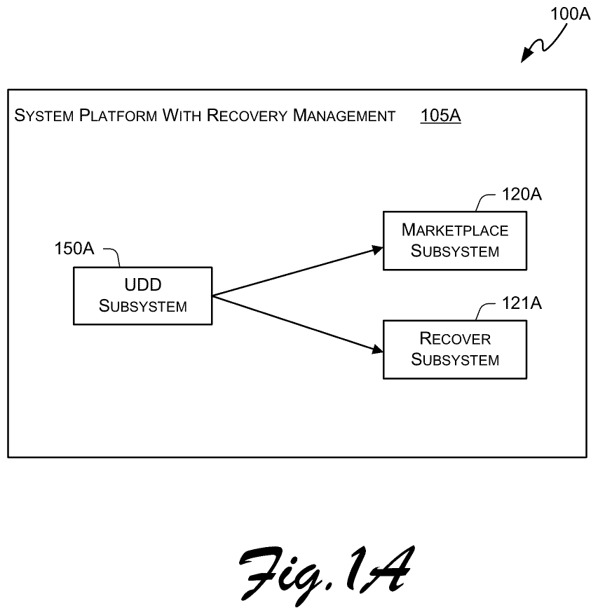

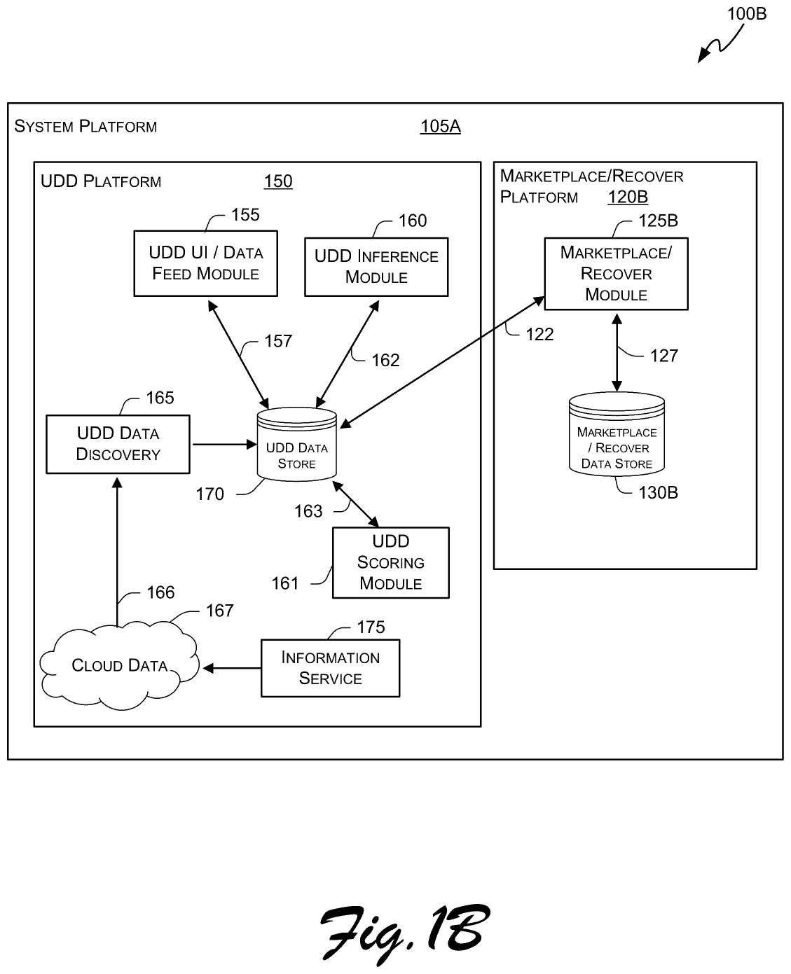

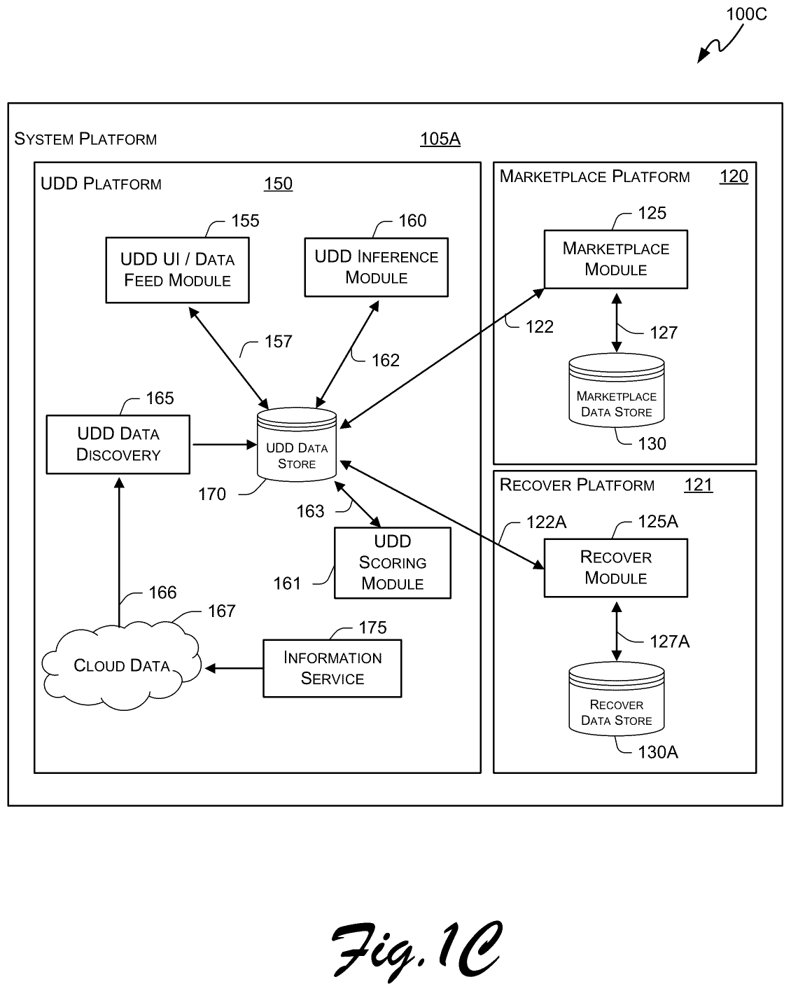

There is provided in FIG. 1 a system 100 including a System Platform 105 of the present invention. Among other aspects, the System Platform 105 provides an online debt marketplace, empowering issuers of defaulted and charged off accounts (the creditor “sellers” in this instance) to liquidate debt portfolios in a manner that safeguards borrowers, sellers, and the buyers who purchase the sellers' debt portfolios. After due diligence and vetting are completed, seller clients can securely upload their debt portfolios, scrub and remove ineligible debt accounts, and market their debt portfolio to a network of pre-certified buyers. Screened buyer clients can then access and review masked portfolio package, evaluate each seller's portfolio, including negotiating final terms, and securely redline and review proposed terms and remove unqualified accounts. The buyer and seller can, through the System Platform 105, execute and request funding, execute a sales agreement online, and download mutually executed copies, receive notification funds have been sent, and once received, securely release files. Aspects of the System Platform 105 provide for the tracking, management, and recall of any account on the same platform.

It can be appreciated that a great deal of sensitive information is transferred between parties to the transactions supported by the System Platform 105, and thus, aspects of the present invention support obtaining, vetting, managing, and auditing buyer, seller, and collection agency compliance data. In this way, borrower PII is protected, and legal and reputational risks for the issuing financial institution may be managed through providing a certified network of buyers who have submitted a universal due diligence package and have been initially screened and vetted, and who continue to be screened for time-sensitive qualifications such as insurance and licensing.

While the System Platform may comprise one or any number of functional modules and sub-platforms, embodiments of the present system 100 include a UDD Platform 150, and a Marketplace Platform 120. The UDD Platform 150 provides a universal due diligence system to manage document requirements from sellers, buyers, and agencies to ensure compliance with federal, state, and local laws, while supporting protection of borrowers' personally identifiable information.

The UDD UI/Data Feed Module 155 provides an interface to clients such as creditors, buyers, agencies, and employees so that they may provide all necessary documentation and information to generate a complete universal due diligence package. Put another way, the Universal Due UI/Data Feed subsystem allows users to feed data into the system for further processing. Inputs from the clients (primarily in the form of due diligence data) may be stored 157 in the UDD Data Store 170, and the data store 170 may be provided locally in a computer system executing the UDD UI/Data Feed Module 155, or may be disposed remotely, and connected to via a network, for instance, if disposed in a server. Data from the UDD Data Store 170 may also be retrieved 157 to allow clients to view, analyze, and/or update the stored information. In addition to clients, a system operator assigned to a compliance function may access universal due diligence packages to conduct analysis and screening of clients, where they can accept or reject documents provided by the client, or request additional documents if needed to complete vetting/screening.

Embodiments of the present invention also provide a UDD Data Discovery Module 165 that is configured to obtain public data 166 that pertains to a particular client from an information service 175; such information may comprise publicly discoverable data regarding creditor, buyer, and agency clients; and may include, for example, bankruptcy filing information, criminal background information, and lawsuit and complaint information. Once obtained, the UDD Data Discovery module 165 writes the public data to the Internal UDD Data Store 170, allowing a Compliance employee to view and analyze the public information via retrieval through the UDD UI Module 155. In one aspect, the Universal Due Diligence Data Discovery module 165 may use natural language processing, machine learning and artificial intelligence to discover legal requirements and feed the system 150 and the UDD Data Store 170.

Various embodiments of the present invention also provide for a UDD Inference Module 160; this module can read client due diligence information regarding creditors, buyers, and agencies, and through artificial intelligence and/or machine learning techniques, may produce inferred knowledge based on information for a client that is stored and available in the Internal UDD Data Store 170. More particularly, the UDD Inference Module 160 further analyzes legal requirements and past entity performance to infer knowledge about entity present and future risk status, through a combination of artificial intelligence, machine learning and other conventional computational methods. Various embodiments can analyze past complaint performance for an agency across geographical regions, income levels, and FICO score levels, and based upon predetermined criteria and algorithms, including in some instances machine learning, infer future performance. Similarly, aspects of the present invention can predict future recovery success levels based on past data. Further, the time to complete certification for clients can be tracked, including time to certify and recertify, thus providing additional insight regarding ability for a particular client to meet screening criteria and therefore show potentially more reliable participation in the vetting and recovery process.

Additional embodiments of the present invention provide for a UDD Scoring module, 161, which may provide detailed scoring rubrics to assist in analysis of various financial data that may be available to system users. In addition to other functions explained in more detail below, the UDD Scoring Module 161 may calculate a score for entity performance and make the score available 163 in the Data Store 170 to users and administrators to satisfy legal requirements to support modules such as a Recover module, explained in more depth below.

Embodiments of the System Platform 105 may also include a Marketplace Platform 120. The Marketplace Platform 120 includes a Marketplace Module 125 that is configured to interface to the UDD Data Store 170, and the Marketplace Data Store 130. In various embodiments, UDD Data Store 170 and the Marketplace Data Store 130 may comprise a single co-located data store or respective separate data stores. The Marketplace Data Store 130 may be provided locally in a computer system executing the Marketplace Module 125, or may be disposed remotely, and connected to via a network, for instance, if disposed in a server. The Marketplace Module 120 may retrieve 122 creditor, buyer, and agency due diligence data including a computed UDD Score (from data store 170, or directly from any of the UDD Data Discovery 165, UI 155, Inference 160, or Scoring Modules 160), and may present the information to creditors and buyers who interact in the marketplace to complete the sale of assets through the Marketplace Module 125. The Marketplace Module 125 is configured to read and write marketplace data to the Marketplace data store 130. In addition, in certain embodiments of the present invention, when a portfolio of accounts is up for sale in the Marketplace, the buyer has the option to send the data to a third party agency such as a credit reporting agency to score the accounts regarding its propensity to pay, as long as the buyer has established a relationship with the credit reporting agency previously. The provided propensity to pay score aids the buyers in regard to pricing of portfolios for sale. The propensity to pay scoring may be aggregated with the UDD scoring (see Scoring Module 161) (discussed in more detail below) to aid the creditor's and buyer's decision regarding doing business with each other, and ultimately pricing of the debt portfolio.

FIG. 1A illustrates another embodiment of a system 100A of the present invention, including a Recover Subsystem 150A addition to the UDD and Marketplace subsystems (120A, 121A). In the overall Recovery Management Solution 105A, the UDD Subsystem 150B, similarly to the UDD Platform 150 described above in regards to FIG. 1, provides knowledge for entities' legal eligibility in the delinquent account Marketplace 120B and Recover 121B subsystems. Also with similarity to the functionality described above in regards to Marketplace Platform FIG. 1, 120, the Marketplace Subsystem 120B provides a the platform for selling/buying collection of delinquent accounts, in addition to other functionality described above in accordance with the Marketplace Platform 120. Finally, in the overall Recovery Management Solution 105A, the Recover Subsystem 121A provides a platform for placing/outsourcing collection of delinquent accounts to collection agencies.

FIGS. 1B and 1C show alternative embodiments of the system shown in FIG. 1, including features integrating the Recovery Management solution 105A as described in accordance to FIG. 1A. In FIG. 1B, Platform 120B integrates the Recover Platform features within the Marketplace Platform, which further has an integrated Marketplace and Recover Module 125B, which provides the functionality of the Marketplace Module 125 discussed above in accordance with FIG. 1 in addition to Recover Functionality, described further herein. The Data Store 130B also provides for functionality of the Data Store 130, in addition to storing Recover module-related data. In FIG. 1C, an alternative system is illustrated providing similar functionality, except that the Recover platform 121 is separate from the Marketplace platform 120, which were integrated together in the embodiment shown in FIG. 1B. The Recover Platform 121 shown in FIG. 1C therefore possesses the separate functionality of the Recover module 125A, which may communicate 122A with the UDD Data Store 170 to obtain or store any desired information. In addition, the Recover module 125A may store or retrieve any necessary information within its own Recover Data Store 130A.

Whether integrated within the Marketplace Platform 120 as shown in FIG. 1B, or as a separate platform 121 as shown in FIG. 1C, the Recover Module/Subsystem is an extension of the existing Marketplace platform; however, it operates within the scope of outsourcing the collection activity to a third-party debt collection agency (also known as “vendor”). The Recover process provides for one of the common steps that are conducted within the original or current creditor recovery efforts. In one aspect, Recover may be considered as a module that co-exists with the Marketplace module in the account recovery effort ecosystem, or providing integrated functionality as illustrated in regards to FIG. 1B.

Assigning accounts to third-party collection agencies is a standard business practice intended to increase portfolio liquidation. Creditors often refer to delinquent receivables at predetermined intervals after identifying that internal efforts are no longer productive. Creditors in the context of the recovery phase or the Recover process are the original creditors and current creditors, respectively the sellers and buyers in the account sale transaction. This means both sellers and buyers of the Marketplace may also use the Recover process.

While this practice is straightforward, creditors must address complexities before and during the process. For example, creditors must ensure that the accounts they outsource meet specific eligibility requirements, and aspects of the Recover process provide for identification and enforcement of such requirements. Account attributes, including the status, delinquency age, and current balance are factors used to determine eligibility for outsourcing, and may be provided all or in part to users accessing the Recover system.

For best results, creditors also need to choose the optimal time to outsource accounts. Forwarding accounts to vendors too early in the delinquency lifecycle leads to increased customer abrasion and increased external recovery costs while outsourcing to vendors too late in the delinquency lifecycle impacts both internal costs and recovery rates, thus the present Recover process may provide guidance for optimal outsourcing timing.

Creditors compensate collection agencies by earning a percentage (contingency fee) of the money they recover. This fee structure is the most prevalent in the industry and is attractive to creditors since they only pay for results achieved. However, these arrangements can quickly become problematic, leading unscrupulous vendors to “skirt the line” to increase recoveries and profits.

Within the Recover Application (or module 125A, 125B), collection agency vendor management encapsulates the process of selecting, managing, and providing the required oversight to manage the vendor effectively from a compliance and financial standpoint. Increased regulatory scrutiny of credit grantors has necessitated this change. In fact, the same due diligence and compliance oversight still applies when creditors select vendors to work on their accounts. Creditors use scores provided by aspects of the present invention such as the Deal Experience Score, Post-Placement Experience Score, and the UDD (Universal Due Diligence) Score during the vendor selection process. Such scores may be computed all or in part by the UDD Scoring Module 161. Additionally, Recover may implement an analytics package to provide real-time business intelligence that becomes the foundation of machine learning that optimizes the automated vendor management decision-making or gives recommendations and insights to human-powered decisions.

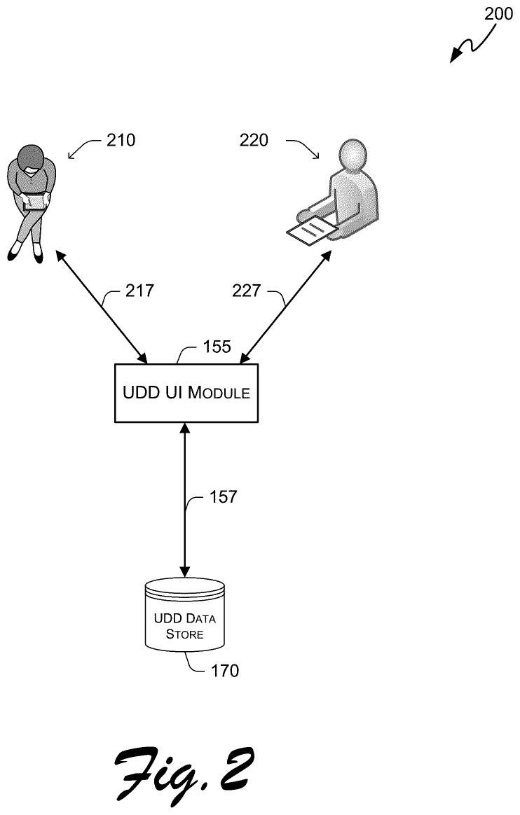

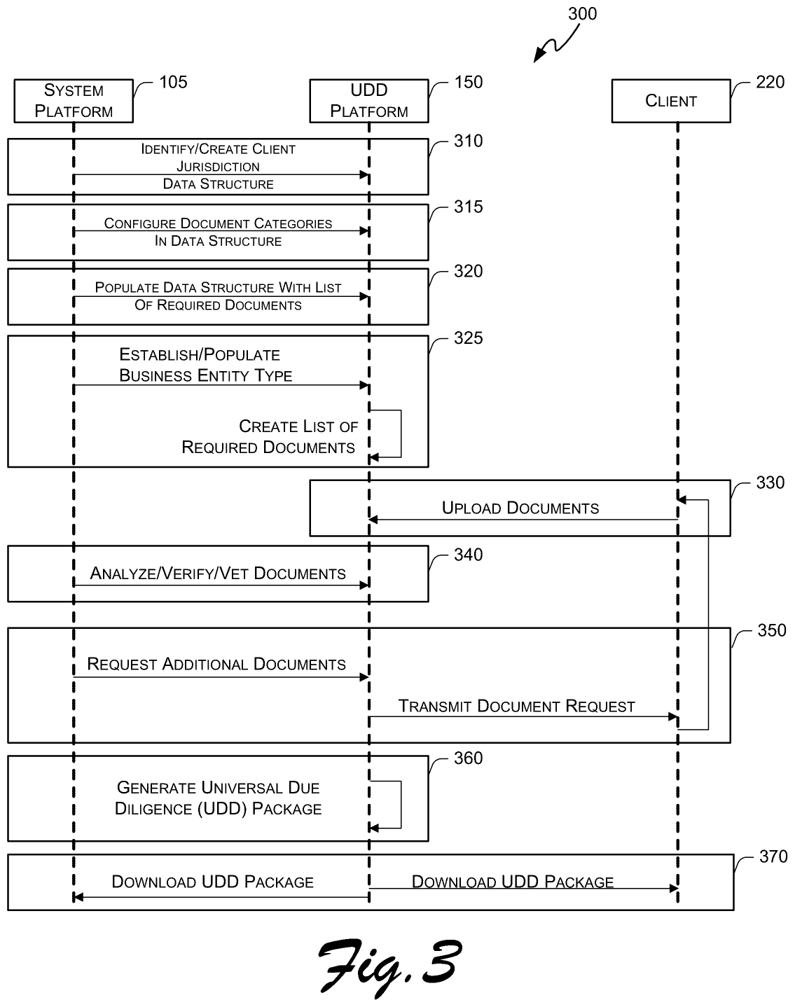

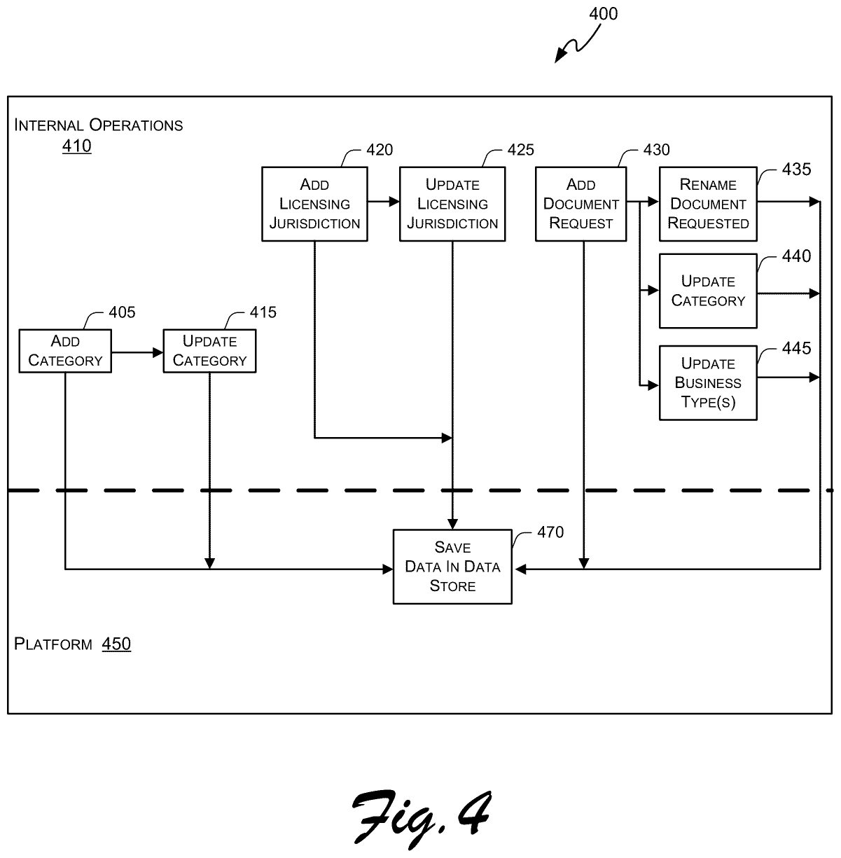

FIG. 2 shows the UDD UI Module 155 and UDD Data Store 170 from FIG. 1 in context of user access provided by a user interface of UDD UI MODULE 155. A more comprehensive discussion of the process is also included and refers to elements of the flow diagram of FIG. 3, and further detailed process explanations are provided in FIGS. 4-6. Regarding FIG. 2, employee operators 210 of the system 105 of FIG. 1 interact 217 with the UDD UI Module 155 to perform a number of tasks, as also shown more fully in FIG. 3 (employee operators may interact with System Platform 105, UDD Platform 150, or both platforms as shown in FIG. 3). In one embodiment, the employee operator 210 initially sets up 217 (FIG. 3, 310) jurisdictions and document categories (FIG. 3, 315), and the jurisdictions and document categories are written 157 to the UDD Data Store 170.

More particularly, referring to FIG. 3, the jurisdiction process setup step 310 establishes fields in a data structure transferring an entity name, entity type (city, county, state, and country) and “Description” of the client entity being set up in UDD. Additionally, licensing information regarding system clients is entered so that sellers (and the embodiments of the present system) may be aware of where a buyer and/or agency can legally transact. Next, the Document Category Setup step (FIG. 3, 315), transfers the “Name”, “Description”, into a category data structure, including a flag indicating whether the category is in use. Example document categories may include, but are not limited to, Business & Officers Information, Legal & Regulatory History, Security & Data Protection, Licensing, Insurance, Employee Hiring, Training & Testing, Quality Assurance & Internal Audit, and Vendor Management & Agency Oversight. Further, in FIG. 3, step 320, the “Name”, “Description”, expiration information when applicable (licenses, insurance, etc.), regarding a client entity is transferred to a foreign key to Document Category, a flag indicating whether the document is required and lastly another flag indicating whether the document must be associated to jurisdictions. Then in FIG. 3, step 325, when a client is initiated in the UDD Platform 150, its business entity type (creditor, buyer, and agency) and its jurisdictions are identified. At this point, the UDD Platform 150 generates (FIG. 3, 325) a list of required documents the client needs to provide, based on the comprehensive list of documents setup previously.

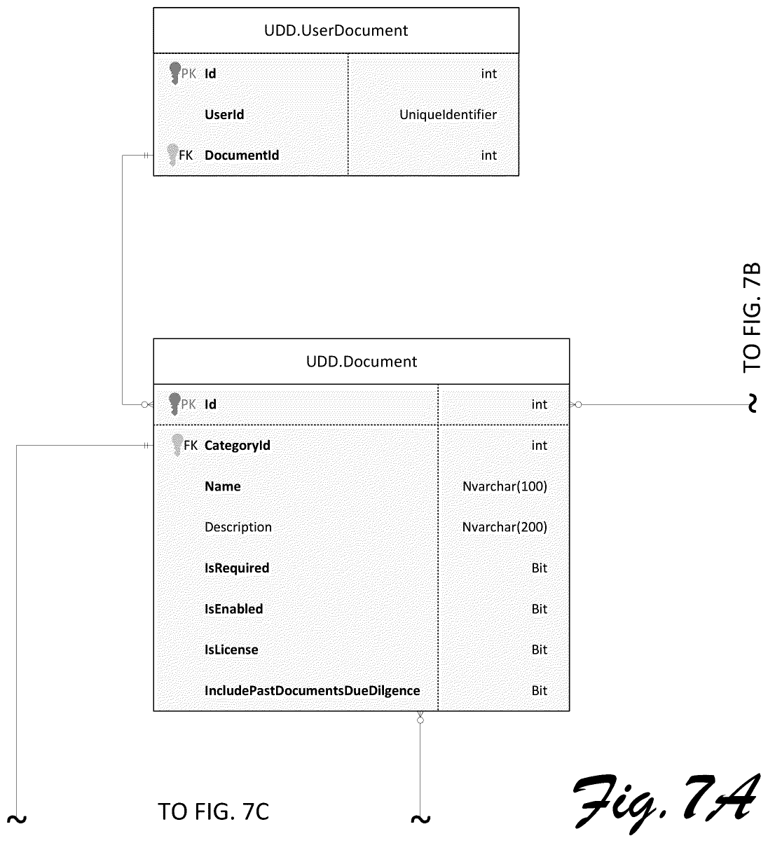

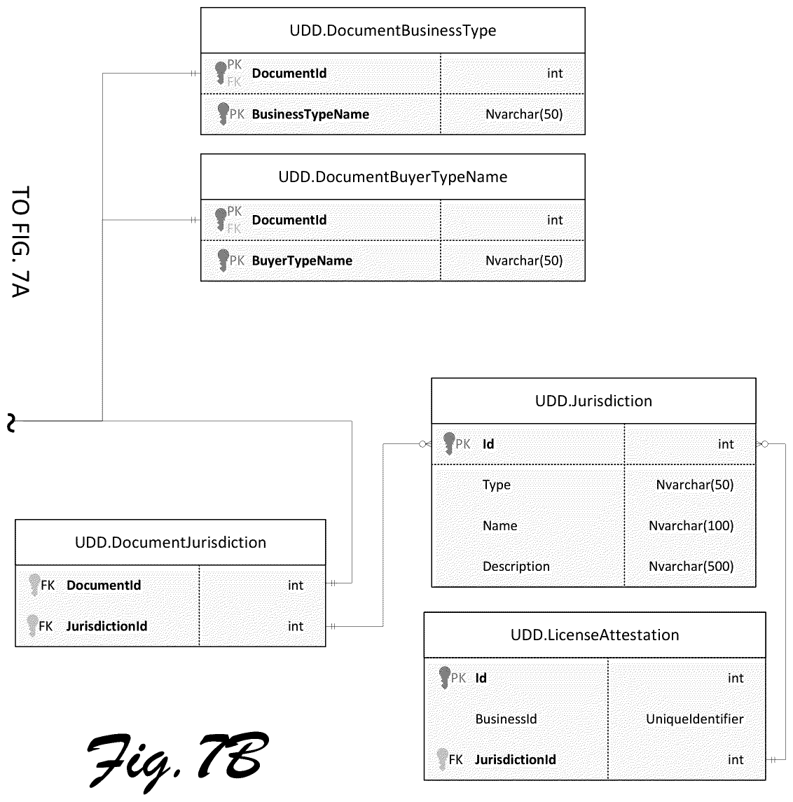

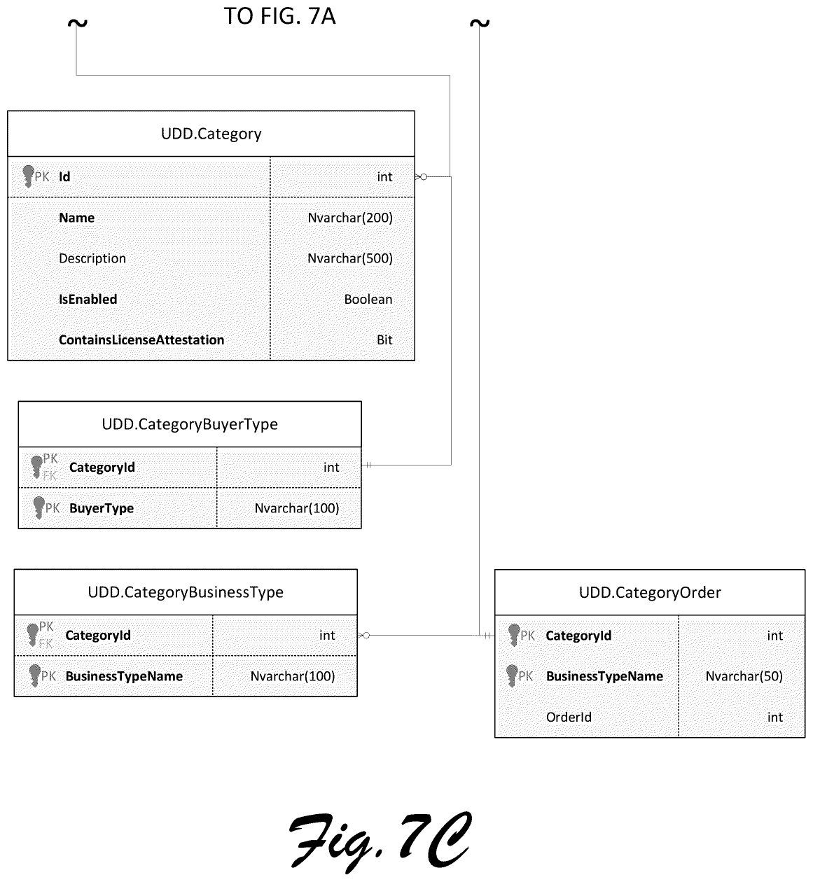

Continuing with FIG. 2, and as explained in regards to FIG. 3, employee operators 210 also set up 217 creditor profiles, buyer profiles, and collection agency profiles, and such profiles are written 157 to the UDD Data Store 170. The creditor, buyer and collection agency profiles are set up in the Marketplace store 130 through the Marketplace module 125. The same profiles are then used by the UDD Module for data association. These profiles may include specific requirements or characteristics of creditors, buyers, and agencies, such as where such entities are licensed to conduct business, and in some embodiments, specific platform-specific factors of whether a creditor requires buyers to utilize only agencies that have been currently certified through the UDD Platform 150. After the aforementioned steps are completed, document requirements are set up 217 (and see FIG. 3, 325) for each particular client who wishes to access the System Platform 105. The established document requirements provide a link between client business entity types (such as creditors, buyers, and collection agencies), and their respective jurisdictions and document categories. Entity-relationship diagrams illustrating exemplary data structures of the present invention are shown in FIGS. 7A-7C, FIGS. 8A-8B, and FIGS. 9-10 as described in more detail below. Document requirements can be updated based on changes in legislation, changes in jurisdictions, additional diligence required for a particular client type, and other requirements as may be needed.

Also interacting 227 with the UDD UI Module 155, clients 220 such as creditors, buyers, and collection agencies may upload 227 documents based upon document requirements established for them by operation employees 210 as a step in completing a universal due diligence document collection. As an additional consideration in determination of required documents, buyer clients 220 may be further categorized as either active or passive buyers. More specifically, active and passive buyer types refer to whether buyer clients collect on the borrower accounts themselves or through a wholly owned or subsidiary collection agencies (active buyer clients) or whether the buyer clients act as investors that employ third party agency networks to collect on the borrower accounts (passive buyer clients). Agencies have very similar certification requirements to an active buyer client with the additional focus on borrower-centric items such as scripts, letters, and other borrower-facing documents. On the other hand, seller client certification may vary substantially in that it focuses on collecting the information a buyer client needs to better understand a debt portfolio prior to bidding on purchasing it. Representative requested documents from seller clients may include completion of a Seller Survey document, which may relate, for instance, to composition of the seller client's debt portfolio, a sample Purchase & Sale Agreement, review of publicly available information regarding complaints, lawsuits, and other seller- or portfolio-related information.

As FIG. 3 illustrates at step 330, based on the list of required documents created in step 325, users will start uploading documents. Specific documents are saved in the data store 170 in addition to upload meta-data such as Upload Date Time, Original File Name, User ID, and Reference Address of the File. The list of required documents created in step 325 may be augmented with additional requests for documents related to the client's business. These documents are usually not included in the comprehensive list created above and are considered supporting documents to a document in the comprehensive list, analyzed on a case-by-case basis. In one embodiment, a document request may contain a Document Name, Document Description, Document Status, and upload meta-data.

In regards to FIGS. 2 and 3, the universal due diligence document collection entered by the client 220 will then be reviewed and may be accepted by the operations employee 210, subject to potential additional submissions or clarifications requested by the employee 210. As FIG. 3 shows in step 340, as documents are uploaded by the clients 220, operations employees 210 can access them from the UDD user interface 155. At this point, operations employees 210 can either accept the document, reject it, or request additional documents 350 and/or information. Any of these actions by the operations employees 210 will trigger the User ID and Date Time to be stored in a history table, associated to the specific document being reviewed. Associations between the Document and the Additional Document Request are also created when the request is entered 350.

The System Platform 105 and/or UDD Platform 150 may provide several notifications including, but not limited to, the following:
Operations employees 210 receive notifications from the UDD Platform 150 once clients 220 have uploaded a predetermined amount (such as 80%, for example) of the required documents to remind the employees 210 to initiate the review process 340.
Operations employees 210 and clients 220 users receive notifications when documents are about to expire (for example, but not by way of limitation, 30 days prior, 10 days prior, the day of expiration, 30 days after).
Operations employees 210 receive notification about when re-certification needs to be initiated for a particular client (for example, but not by way of limitation, 30 days prior, 10 days prior, the day of expiration, 30 days after).
Clients 220 receive notification when additional documents are requested by operations employees 210. Operations employees 210 receive notification when additional documents are uploaded.

Once any additional documents are requested 350 and uploaded 330/and analyzed 340, a Universal Due Diligence Package may be generated 360. In one embodiment, the Due Diligence Package is a concatenation of all documents provided during the document registration process (described above in regards to FIG. 3 steps 310-360). Documents that expire, such as licenses and insurance policies, are updated dynamically when a newer document is uploaded and accepted. This package contains all of the reviewed and approved documents and information regarding a specific client, and is downloaded 370 utilized by clients 220 and in the System Platform 105 and the Marketplace Platform 120 to provide clients 220 with the comprehensive information needed to sell or purchase debt portfolios with reduced risk to all of the participating clients. Historical recertification applications can be downloaded if the downloading client chooses. The Universal Due Diligence package may be updated periodically, with additional documents or time-sensitive information such as licensing and insurance information, and in various embodiments of the present invention, reminders for required update documents (e.g. insurance policies or licensing documents) may be automatically generated and transmitted to the relevant client or operations personnel.

FIG. 4 presents a flow chart regarding additional details of the document setup process between internal operations (top, 410) and the Platform 450, which may comprise the System Platform 105, the UDD Platform 150, or both. Document setup method steps shown in FIG. 4 are utilized to enable analysis, vetting, and verification of documents after data structures involving client requirements are populated. In various embodiments, client requirements are split into categories based on a client type. Each category created 405, 415 is assigned to a client type. Exemplary client categories may include, for example, Business+Officers, Legal+Regulatory, Security+Data, Insurance, Licensing, References, and Supporting Documents. Active buyers (described above) have all identified categories listed, with an additional category identified as “Active Buyer.” The Licensing category produces jurisdiction requirements, which are added and updated in steps 420, 425. In various implementations, a jurisdiction may include a country, province, state, county, or city. Further, in one embodiment each category should have a minimum of one document requested to be active. In one aspect, document requirements are assigned a client type. Licensing documents can be assigned to multiple jurisdictions. In various steps show in FIG. 4, Document requests may be added 435, the request may be renamed 435, one or more categories may be updated 440, and one or more business types may be updated 445. Each of the above actions may result in one or more data structures being saved 470 in a data store 170 for further use within the UDD Platform 150, System Platform 105, and/or Marketplace Platform 120.

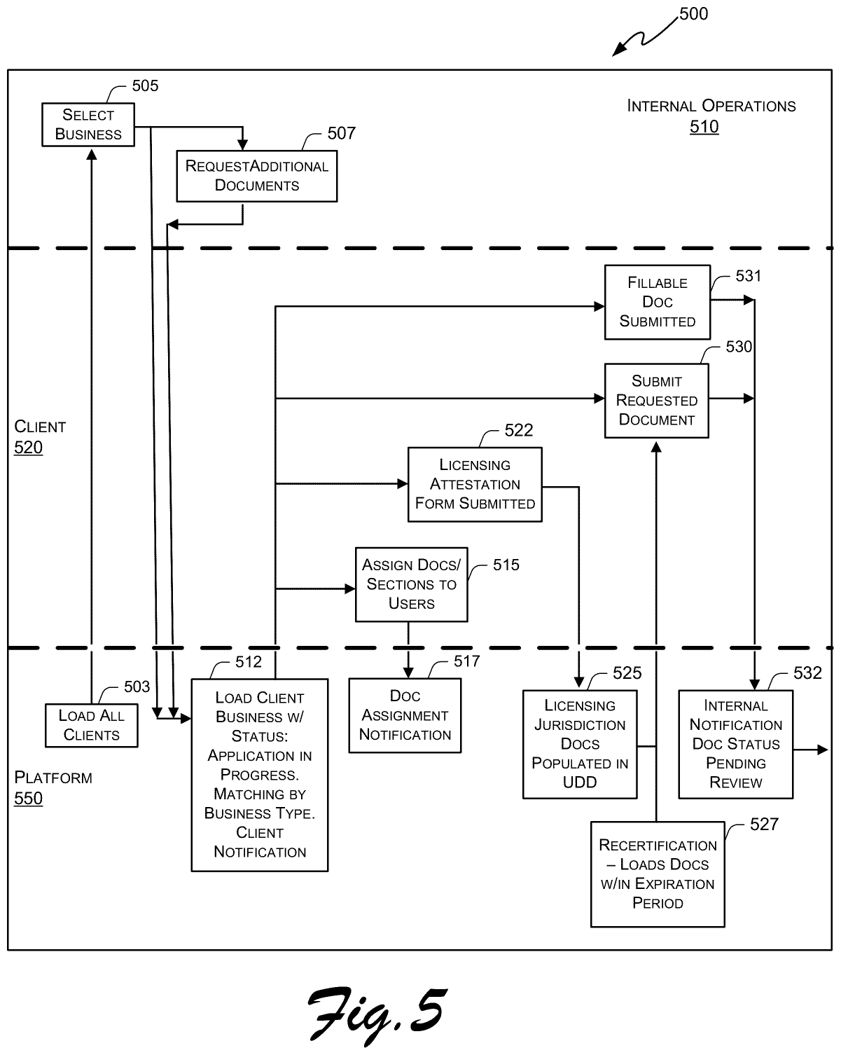

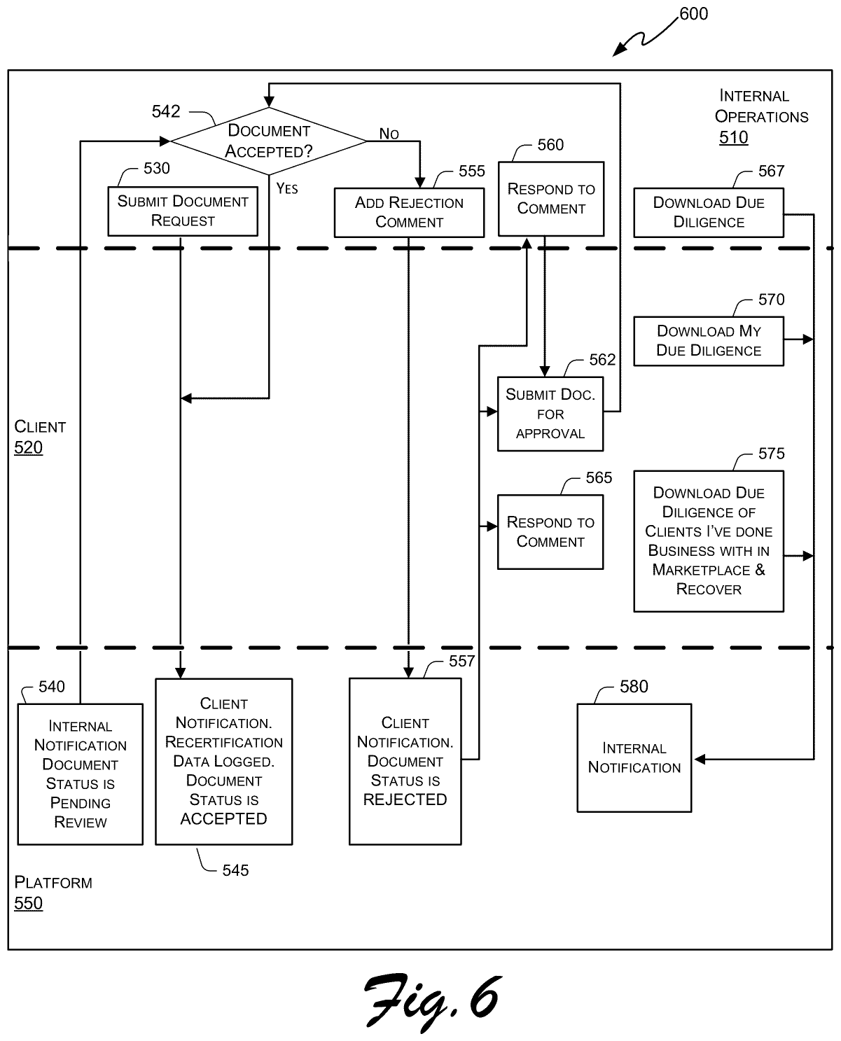

FIGS. 5 and 6 illustrate another embodiment of the present invention, including document registration, which is used to certify clients into the present invention's debt portfolio sale and purchase network through a document identification, submission, vetting, and approval process. The flow diagrams 500 and 600 are divided into three lanes, the top lane 510 corresponding to internal operations related to function and execution of aspects of the present invention, a center lane 520 corresponding to client-related process steps, and a bottom lane 550 regarding platform-related (such as the UDD Platform, System Platform, and/or Marketplace Platform) method steps. In FIG. 5, all client data structured are loaded 503 by the Platform, and subsequently, a business client is selected 505 by internal operations 510. Optionally, additional documents may be requested 507 of the business client, and processing continues with loading a client business data structure with the status Application in Progress 512. Matching occurs by client business type, and the appropriate client receives the intended notifications. At various points in time, users will be notified about documents that require signatures using a secure document signature interface, and once the document is electronically signed, the document will be ingested by the platform once completed. After step 512, a number of client-related method steps may be undertaken; documents and/or sections of required documents may be assigned 515 to specific users to be populated and/or completed along with a platform-provided notification of the task needing completion 517, a system-provided licensing attestation form may be provided 522 for client input and completion. In one embodiment, the licensing attestation comprises a form listing all jurisdictions for input to a data structure; the data is provided by the client. Further, documents associated with the identified jurisdiction are then requested 522 from the client. After request and submission step 522, licensing jurisdiction documents are populated 525 in the UDD platform, and possible recertification platform process 527 loads documents for completion/update that are scheduled to expire within a predetermined expiration period (for example, thirty days). From the client side, the requested documents may be submitted 530, and/or a fillable form document may be submitted 532, and after submission, the platform 550 may provide internal notification 532 that the submitted document is pending review. The process continues from step 532 into the process diagram 600 shown in FIG. 6.

In FIG. 6, the approval process is further illustrated; to summarize, documents that are uploaded must go through an approval process. Documents are either accepted or rejected through an analysis/vetting/approval process as discussed in regards to FIG. 3, step 340. Accepted documents are added to the Due Diligence Package. Rejected documents require a comment from the internal operations Compliance Department. The Compliance Department can request additional documents at any time as necessary to clarify or complete a Due Diligence Package.

Referring to the process 600, the step 540 provides internal notification that a document status is pending review, and once internal vetting/analysis is completed, a determination is made as to whether the document is accepted 542. If so, or if internal operation 510 submits a document request 530, the Client is notified 545, recertification data is logged and the document status is set to “accepted.” In one embodiment, clients recertify 365 days after being admitted as a client to the certified network of the present System Platform 105. If the document is not accepted 542, then a rejection comment is added 555, and the client is notified 557 that the document status is rejected. Upon receiving notification of rejection, responses to comments may be originated 569 by internal operations 510, or responded to 565 by the client 520, and an updated document can be submitted 562 for approval 542 by the client 520. After a client has been accepted into the client network of the present invention's System Platform 105, a Document Portal can be accessed, wherein Clients and the internal operations Compliance Department can view the Consumer CX/BX Score, reporting, and download the Due Diligence Package.

In accordance with aspects of the present invention, the data associated with various objects are organized in data structures in the form of entity-relationship diagrams shown in FIGS. 7A-7C, FIGS. 8A-8B, and FIGS. 9-10. While the exemplary data structures shown in these figures are representative of embodiments of the present invention, those of skill in the relevant arts appreciate that data may be stored and operated upon by methods of the present invention in many alternate configurations.

FIGS. 7A-7C provide a schematic presentation of an entity-relationship diagram showing an embodiment of a data structure of the present invention relating to the primary UDD documents and their relationships. To provide an example of contents of the several figures, FIG. 7A illustrates several data objects/entities related to UDD documents; for example, the UDD. UserDocument object, which has Id, UserId, and DocumentId attributes, and relates to zero or more UDD.Document objects through an DocumentID primary key field. The UDD document has attributes reflecting data items including a CategoryId, Name, Description, IsRequired flag, IsEnabled flag, IsLicense flag, and IncludePastDocumentDueDilligence flag. The illustrated entity/object relates to objects on FIGS. 7B, and 7C, as illustrated through the off-page relationship connectors. FIG. 7B similarly illustrates a UDD.DocumentBusinessType object, a UDD.DocumentBuyerTypeName object, and a UDD.DocumentJurisdiction object, each of which must have exactly one cardinality, and are linked (off-page) to zero or many UDD.Documents as shown on FIG. 7A. Further, a single UDD.DocumentJurisdiction links UDD.Documents objects with UDD.Jurisdiction objects, each of which may also relate to a zero or more UDD.LicenseAttestation objects. FIG. 7C shows the relation, through off-page connectors to FIG. 7A, of zero or many UDD. Category objects linked through an ID primary key field to the UDD. Document object in FIG. 7A, as is the UDD. CategoryBuyerType object which appends an optional BuyerType attribute to UDD.Category and the UDD. CategoryBusinessType which appends an optional BusinessTypeName attribute to UDD.Category. Zero or more UDD.Category objects relate to a UDD.CategoryOrder object, and through an off-page connector to zero or more UDD. Document objects are further shown in FIG. 7A.

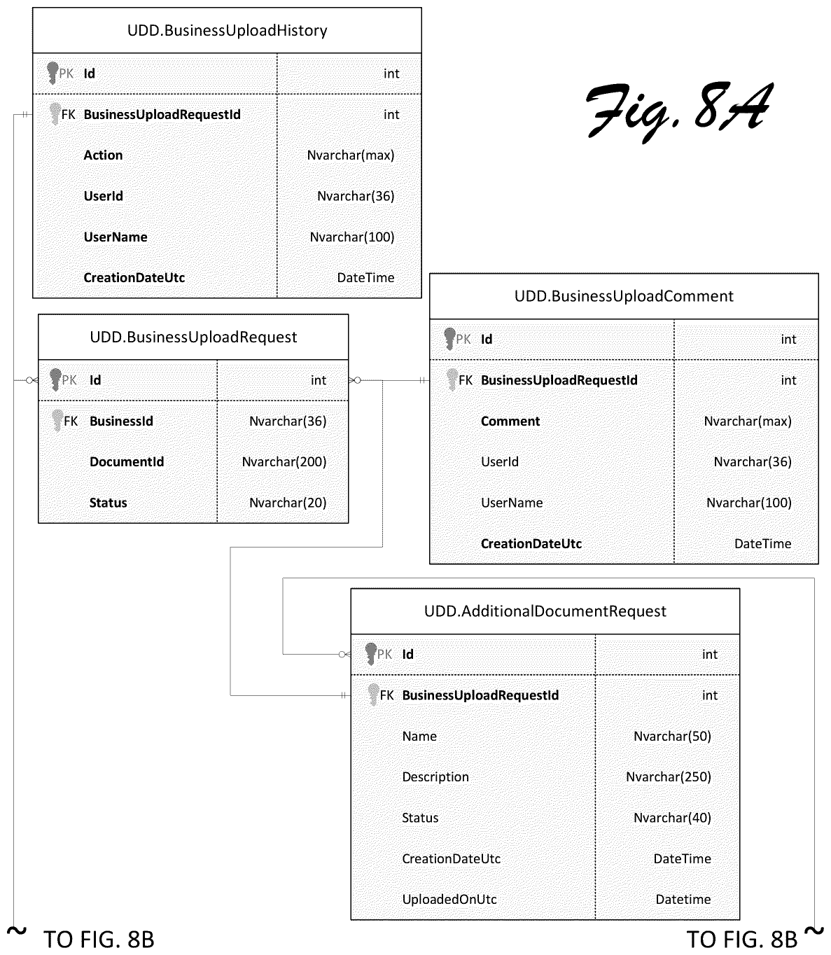

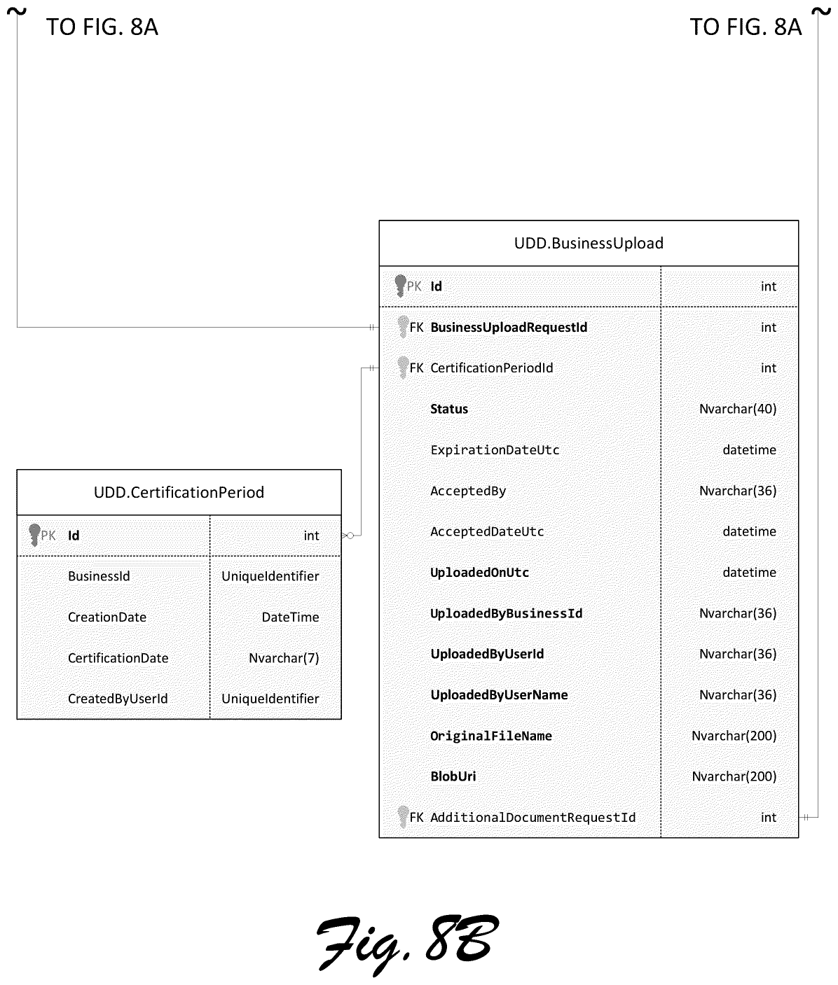

FIGS. 8A-8B provide additional schematic presentations of an entity-relationship diagram showing an embodiment of a data structure of the present invention. The entities/objects of FIGS. 8A-8B may relate to aspects of the present invention regarding UDD document upload requests, tracking document uploads and vetting documents provided by clients of the System Platform. In FIG. 8A, one UDD.BusinessUploadRequest object relates to zero or more UDD.BusinessUploadHistory objects, also relates to zero or more UDD.BusinessUploadComment objects, zero or more UDD.AdditonalDocumentRequest objects, and lastly zero or more UDD.BusinessUpload objects through off-page connector. UDD.BusinessUpload object shown on FIG. 8B also relates to zero or more UDD.CertificationPeriod objects.

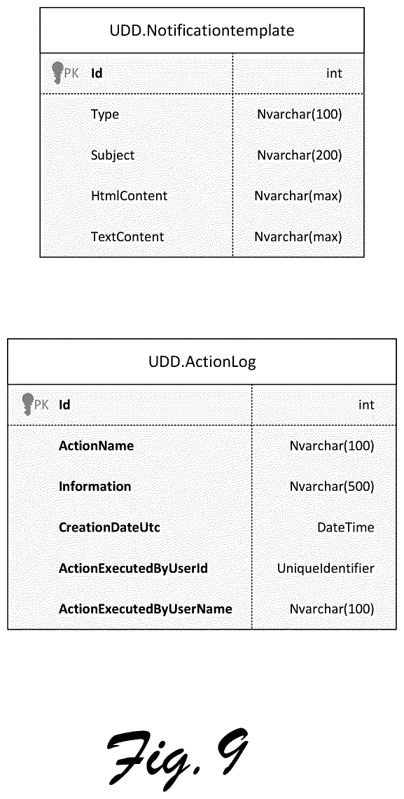

FIG. 9 provides two separate entity-relationship objects, including a first UDD.NotificationTemplate object including an ID primary key field, and Type, Subject, HtmlContent, and TextContent attributes that may be used to store exemplary notification templates that can be provided to System Platform clients. A UDD.ActionLog object includes an ID primary key field, and ActionName, Information, CreationDateUtc, ActionExecutedbyUserID, and ActionExecutedByUserName attributes that may be used to store historical actions taken regarding a UCC data item.

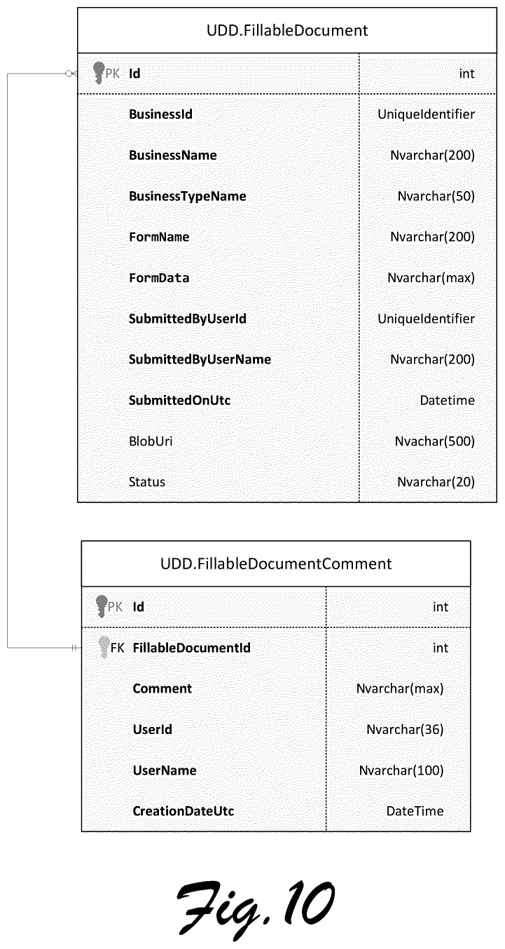

FIG. 10 provides another schematic presentation of entity-relationship diagrams showing an embodiment of a data structure of the present invention. Two object entities are provided in the exemplary diagram with a UDD.FillableDocument object/entity having a primary key field of ID, with attributes including BusinessID, BusinessName, BusinessTypeName, FormName, FormData, SubmittedByUserId, SubmittedByOtherName, SubmittedOnUtc, BlobUri, and Status. Zero or more of the UDD.FillableDocument objects/entities respectively relate to a FillableDocumentId foreign key field of an UDD.FillableDocumentComment object having an ID primary key field, and Comment, UserId, UserName, and CreationDateUtc attributes. The objects and attributes of FIG. 10 may provide for storage of customer-filled documents along with commentary and tracking data provided by System Platform employees.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A method for screening a client as a potential buyer or seller of debt assets, the method comprising:
setting up client jurisdictions, document categories, list of required documents, and business entity types;
creating a list of required documents to be uploaded for the client for completion of a universal due diligence packet;
requesting the client upload the documents, and receiving said documents uploaded by the client;
analyzing the uploaded documents for completeness;
requesting upload of any optional additional information from the client, and receiving said uploaded information from the client;
generating a universal due diligence (UDD) package; and
formatting the UDD package for downloading by another user.

2. The method of claim 1, further comprising computing metrics related to a buyer or seller's performance in managing the sale, transfer, and/or collection of debt assets.

3. The method of claim 2, wherein the metrics comprise a Borrower Experience (BX) Score.

4. The method of claim 2, wherein the metrics comprise a Deal Experience (DX) Score.

5. The method of claim 2, wherein the metrics comprise a Post-Sale Experience (PDX) Score.

6. The method of claim 2, wherein the metrics comprise a Universal Due Diligence (UDD) Score.

7. The method of claim 3, wherein the BX Score is computed as a function of one or more of:
number of substantiated complaints received against a particular buyer/agent;
post-sale response rates for the particular buyer/agent;
post-sale performance timeframes for the particular buyer/agent; and
performance of the particular buyer/agent to a funding deadline.

8. The method of claim 3, wherein the BX Score is computed from a total number of substantiated complaints against a particular buyer divided by the total number of accounts purchased and/or serviced by that buyer.

9. The method of claim 8, further comprising multiplying the complaint/accounts purchased quotient by a predetermined scaling constant.

10. The method of claim 4, wherein the DX Score is computed as a function of responsiveness of a party to a funding deadline timeframe.

11. The method of claim 5, wherein the PDX Score is computed as a function of post sale buyer-seller response times.

12. The method of claim 6, wherein the UDD Score is computed be computed as a percentage completion of a certification/recertification process.

13. The method of claim 1, further comprising:
managing post-sale consumer complaints through a consumer complaint portal, and tracking performance of the buyer and/or collection agent utilized by the buyer; and
reporting metrics related to the tracked performance.

14. The method of claim 1, further comprising:
monitoring a client recertification criterion;
providing a notice to the client regarding the requirements to recertify;
accepting uploaded documents from the client regarding the certification; and
analyzing said documents to determine whether recertification requirements are met.

15. The method of claim 1, wherein setting up client jurisdictions, document categories, list of required documents, and business entity types further comprises:
setting up client jurisdictions by establishing fields in a nontransitory UDD.Jurisdiction data structure by transferring an entity name, entity type including one of city, county, state, and country, and description of the client into the respective fields.

16. The method of claim 1, wherein setting up client jurisdictions further comprises:
setting up client jurisdictions by establishing fields in a nontransitory data structure by transferring an entity name, entity type (city, county, state, and country) and description of the client into respective fields; and
entering licensing information regarding the client into a second nontransitory data structure to enable sellers to aware of where the client and/or agency can legally transact.

17. The method of claim 1, wherein setting up document categories further comprises:
transferring name and description data regarding a document into a nontransitory category data structure, including a flag indicating whether the category is in use.

18. The method of claim 17, wherein the category further includes one or more of: Business & Officers Information, Legal & Regulatory History, Security & Data Protection, Licensing, Insurance, Employee Hiring, Training & Testing, Quality Assurance & Internal Audit, and Vendor Management & Agency Oversight.

19. The method of claim 18, further comprising transferring via a foreign key to nontransitory data structure document category:
license and/or insurance expiration information regarding a client entity;
a flag indicating whether a referenced document is required; and
a second flag indicating whether the document must be associated to jurisdictions.
